(19) United States
(12) Patent Application Publication
(10) Pub. No.: US 2006/0204249 A1
(43) Pub. Date: Sep. 14, 2006

(54) Toner cartridge and image forming apparatus

(75) Inventor: Tadashi Sugiyama, Shizuoka-ken (JP)

Correspondence Address: FOLEY AND LARDNER LLP;SUITE 500, 3000 K STREET NW, WASHINGTON, DC, 20007, US

(73) Assignees: KABUSHIKI KAISHA TOSHIBA; TOSHIBA TEC KABUSHIKI KAISHA

(21) Appl. No.: 11/076,378

(22) Filed: Mar. 10, 2005

(51) Int. Cl. G03G 15/00; G03G 15/08

(52) U.S. Cl. 399/12; 399/262

(57) ABSTRACT

A toner cartridge 106 has a cartridge body 160a configured to be insertably for use in an image forming apparatus and holding a toner in it and a grip 106b provided on a proximal end of the cartridge body 106a. The grip 106b has such a shape that the toner cartridge 106 is completely inserted into the image forming apparatus when the grip is fitted in a recess 121 or on a projection provided on a pusher 117, the shape being specific to the toner cartridge 106 or toner contained in the cartridge body 106a.

### BACKGROUND OF THE INVENTION

1. Field of the Invention

The present invention relates to a rotation type bottle toner cartridge and an image forming apparatus.

2. Description of the Related Art

In an image forming apparatus such as a copying machine, facsimile equipment and printer, use is sometimes made of a rotation type bottle toner cartridge. The rotation type bottle toner cartridge is so formed as to be detachably fitted in the image forming apparatus and, when a toner within the cartridge is spent, allow the user to replace the cartridge with a new one.

Incidentally, a copying machine maker provides details of toner cartridges which, from the standpoint of a product control and printing quality, they recommend for use in their copying machines. This is because, if use is made of any toner cartridge of a poor quality, a printing quality is lowered and, sometimes, a copying machine develops malfunction.

Since users may not be aware of the problems caused by sub-standard toner cartridges, copying machine manufacturers provide toner cartridge specifications so as to maintain the printing quality on their copying machine, and recommend the use of these toner cartridges so as to prevent problems and malfunctions of the copying machine.

Since, depending upon the type of toner cartridge used, there arises a problem or failure of the copying machine, it is sometimes necessary to identify the kind of toner cartridge in the copying machine. It is considered that, even if the quality of the toner cartridge is not poor, the user may sometimes use an unfit toner cartridge inadvertently, for example, a toner cartridge whose color is not matched.

In order to solve such problems, several proposals have been made to identify the kind of toner cartridge. For example, an electrophotographic copying machine is proposed, in JPN PAT APPLN KOKAI PUBLICATION NO. 6-35320 in which, on an insertion direction depth side of a toner cartridge, a projection is provided to allow it to be fitted in a recess provided on a copying machine side and, by this projection/recess matching, the use of any unfit toner cartridge is prevented.

If, however, a key is provided at the insertion direction depth side of the toner cartridge as in the KOKAI PUBLICATION above, it is necessary for a recess to be provided on the copying machine side. This involves a cost problem for modifying the copying machine. Where a grip for a detaching operation is provided on the insertion direction front side of the toner cartridge, it is further necessary to provide recess or projection on both ends of the toner cartridge.

### BRIEF SUMMARY OF THE INVENTION

The present invention has been achieved with these circumstances in mind, and the object of the present invention is to provide a toner cartridge and image forming apparatus which, without complicating the structure of the apparatus, can prevent any unfit use of the toner cartridge and can achieve a simplified attaching/detaching operation.

In order to solve the task of the present invention and achieve the object of the present invention, the toner cartridge and image forming apparatus of the present invention are structured as explained below.

(1) A toner cartridge insertably for use in an image forming apparatus comprises

a toner cartridge body configured to hold a toner in it; and

a grip provided on a proximal end of the cartridge body and having such a shape that the toner cartridge is completely inserted into the image forming apparatus when the grip is fitted in a recess or on a projection provided in or on the image forming apparatus, the shape being specific to the toner cartridge or toner contained in the cartridge body.

(2) An image forming apparatus comprises

an image carrier provided within an apparatus body;

an image forming unit provided within the apparatus body and configured to form an electrostatic latent image on the image carrier;

a developing unit provided within the apparatus body and configured to supply the electrostatic latent image to the toner to form a toner image;

a transfer unit provided within the apparatus body and configured to transfer the toner image to a transfer medium;

a rotation type bottle toner cartridge configured to be insertably fitted in the apparatus body to supply the toner to the developing unit; and

a support member provided on a front side within the apparatus body and configured to have a recess or projection for supporting the toner cartridge insertably fitted in the apparatus body, the toner cartridge comprising a cartridge body configured to hold the toner in it and a grip provided on a proximal end of the cartridge body and having such a shape that the toner cartridge is completely inserted into the image forming apparatus when the grip is fitted in the recess or on the projection, the shape being specific to the toner cartridge or toner contained in the cartridge body.

According to the present invention it is possible to, without complicating the structure of the apparatus, prevent any unfit use of the toner cartridge and to simplify a fitting operation of the toner cartridge.

Additional objects and advantages of the invention will be set forth in the description which follows, and in part will be obvious from the description, or may be learned by practice of the invention. The objects and advantages of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate presently preferred embodiments of the invention, and together with the general description given above and the detailed description of the preferred embodiments given below, serve to explain the principles of the invention.

FIG. 1 is a perspective view showing an electrophotographic copying machine according to a first embodiment of the present invention;

FIG. 2 is a diagrammatic view showing an inner structure of a copying machine body according to the embodiment;

FIG. 3 is a perspective view showing a copying machine body of the present embodiment with a cover of the machine body in an opened state;

FIG. 4 is a perspective view showing the copying machine body of the present embodiment with a toner cartridge in a removed state;

FIG. 5 is a diagrammatic view showing the toner cartridge, pusher and drive unit;

FIG. 6 is a perspective view showing a corresponding relation between a recess and a grip in the present embodiment;

FIG. 7 is a perspective view showing a corresponding relation between another grip and an associated recess in the present embodiment; and

FIG. 8 is a diagrammatic view showing a toner cartridge, a pusher and drive unit according to another embodiment of the present invention.

### DETAILED DESCRIPTION OF THE INVENTION

With reference to the drawing, an explanation will be made below about first and second embodiments of the present invention.

### First Embodiment

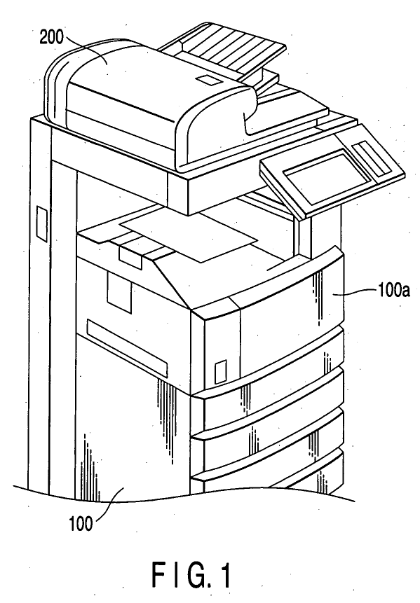

The first embodiment of the present invention will be explained below with the use of FIGS. 1 to 7.

(Structure of Electrophotographic Copying Machine)

FIG. 1 is a perspective view showing an electrophotographic copying machine according to the first embodiment of the present invention. As shown in FIG. 1, this electrophotographic copying machine (image forming apparatus) comprises a copying machine body (apparatus body) 100 and an automatic document feeding apparatus 200. The copying machine body 100 is box-like in configuration and an openable cover 100a is provided on the side face of its front side. The automatic document feeding apparatus 200 is of such a type as to feed document sheets one by one and it is so provided as to be rotatable about its one pivotal end side.

(Structure of Copying Machine Body 100)

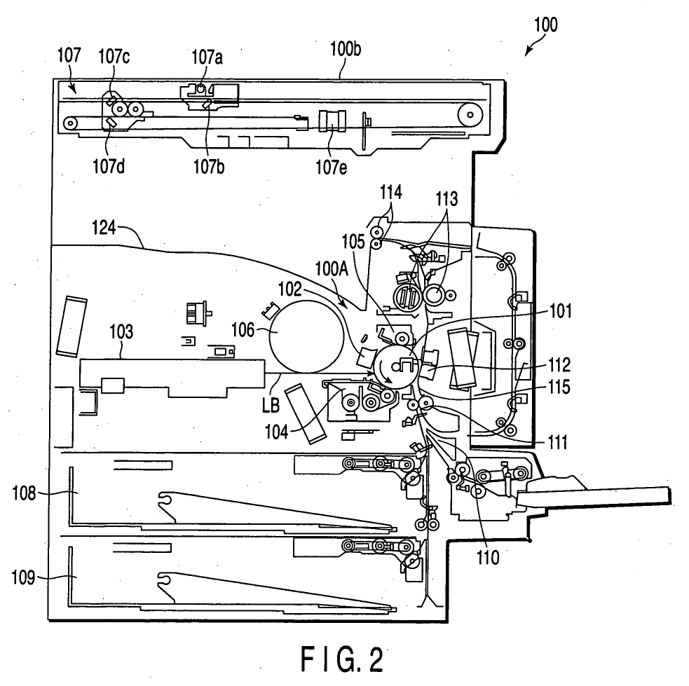

FIG. 2 is a diagrammatic view showing an inner structure of the copying machine body 100 according to the present embodiment. As shown in FIG. 2, an image forming unit 100A is provided on one end at the center area of the copying machine body 100. The image forming section 100A has a photosensitive drum 101 (image carrier) rotatable in the direction of an arrow. Around the photosensitive drum 101 and along a rotation direction of the photosensitive drum 101 are arranged an electric charger 102 for charging the surface of the photosensitive drum 101, a laser unit 103 (image forming unit) for forming an electrostatic latent image on the surface of the drum 101, a developing unit (104) for developing the electrostatic latent image by a toner into a visual image on the drum 101, a transfer guide 115 (transfer unit) for transforming the toner image on the drum 101 onto a sheet, and a cleaning unit 105 for cleaning residual toner off the photosensitive drum 101.

The developing unit 104 holds a two-component developing agent comprising a carrier and toner. Above the developing unit 104, a toner cartridge 106 is mounted for supplying the toner to the developing unit 104. The toner cartridge 106 is detachably mounted within a cartridge holding section 100c (see FIG. 4) of the copying machine body 100. The toner cartridge 106 will be described below in more detail.

A document rest 100b is provided at the upper surface of the copying machine body 100 to allow a document to be placed on it. The automatic document feeding apparatus 200 is provided on the upper side of the document rest 100b. Further, a scanner 107 is provided at the lower side of the document rest 100b to expose the document on the document rest with light. The scanner 107 has a light source 107a for emitting light onto the document, first to third reflection mirrors 107b to 107d, and a light receiving element 107e for receiving the light which is guided by the first to third reflection mirrors 107b to 107d.

Upper and lower sheet supply cassettes 108 and 109 are provided at the lower side within the copying machine body 100 to hold sheets therein. The sheet in the sheet supply cassettes 108 and 109 is conveyed upward past a sheet conveying system 110. In the conveying system 110 are provided a pair of register rollers 111, an image transfer unit 112, a pair of fixing rollers 113, and a pair of discharge rollers 114.

At a time of forming an image, a document on the document rest 100b is illuminated with the light coming from the light source 107a. The light is reflected on the document and, after its direction is changed by the first to third reflection mirrors 107b to 107d, is received by the light receiving element 107e. By doing so, an image on the document is read out. Based on this read-out information, the laser unit 103 illuminates the surface of the photosensitive drum 101 with laser light LB. Since the surface of the photosensitive drum 101 is previously charged by the charger 102 to a negative polarity, it is illuminated with the laser light LB from the laser unit 103 and thus exposed with light. By doing so, a drum surface potential corresponding to an image portion of the document approaches 0 in accordance with its image density to allow an electrostatic latent image to be formed on the surface of the photosensitive drum 101. The electrostatic latent image faces the developing unit 104 side as the drum 101 is rotated and, at that facing position, a toner is attracted to the latent image on the drum to provide a visual image.

At this time, the sheet which has been taken out from the sheet supply cassette 108 or 109 is conveyed within the conveying system 110 and sent into the image transfer unit 112 between the photosensitive drum 101 and the transfer guide 115. By doing so, the visual image on the drum 101 is transferred to a positively charged sheet.

The image thus transferred is conveyed to the fixing rollers 113 where it is heated under pressure. By doing so, the image is transferred to the sheet. And the image-fixed sheet is discharged by the discharging rollers 114 onto a sheet discharge tray 124.

Residual toner on the surface of the photosensitive drum 101, after being removed by a cleaning unit 105, is returned back to the developing unit 104 by a recovering mechanism not shown. When the toner in the developing unit 104 is spent by the repetitive developing process, new toner is supplied from a toner cartridge 106 to the developing unit 104.

(Toner Cartridge 106 and its Surrounding Area)

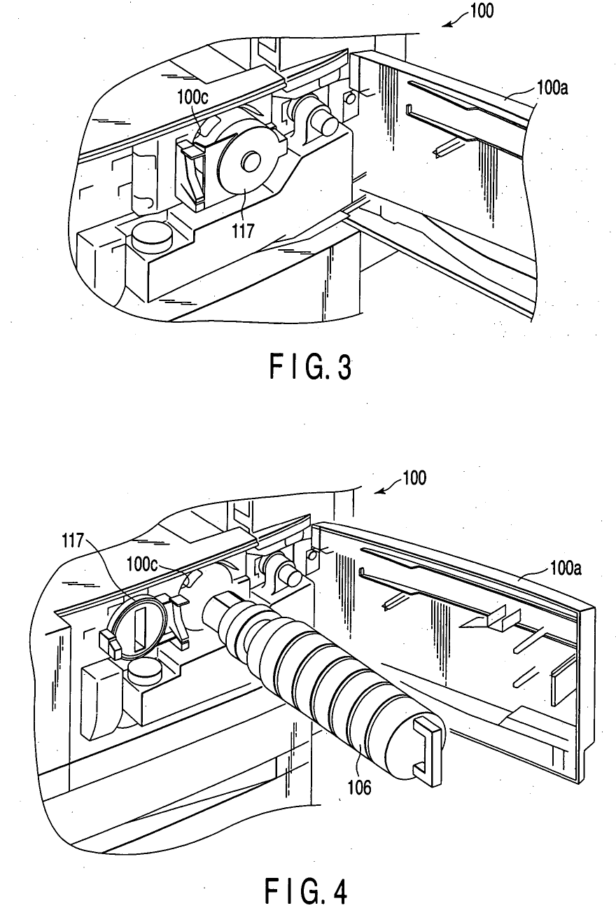

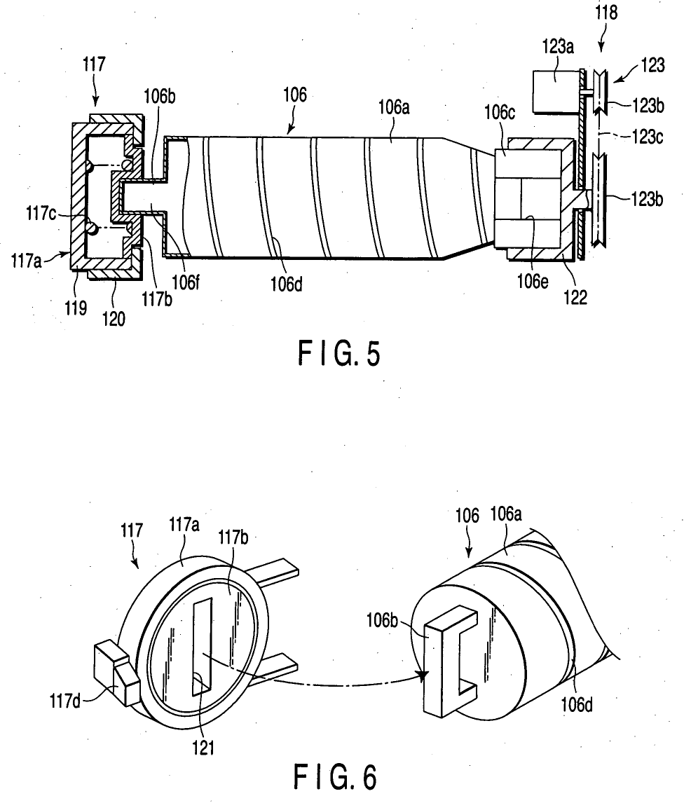

FIG. 3 is a perspective view showing the copying machine body 100 of the present embodiment with its cover 100a in an opened state. FIG. 4 is a perspective view showing the copying machine body 100 of the present invention with its toner cartridge 106 in a detached state. As shown in FIGS. 3 and 4, the cartridge holding section 100c is provided at the upper center portion of the copying machine body 100 to hold the toner cartridge 106. The cartridge holding section 100c is a cylindrical cavity and, at its front side, a pusher 117 is provided for pushing the toner cartridge 106 into copying machine body 100. Within the copying machine body 100, a drive unit 118 (see FIG. 5) is provided to allow the toner cartridge 106 to be rotated.

(Structure of Toner Cartridge 106, Pusher 117 and Drive Unit 118)

FIG. 5 is a diagrammatic view showing the toner cartridge 106, pusher 117 and drive unit 118 of the present embodiment. FIG. 6 is a perspective view showing a corresponding relation between a grip 106b and a recess 121 according to the present embodiment.

(Structure of Cartridge 106)

As shown in FIGS. 5 and 6, the toner cartridge 106 comprises a cartridge body 106a for holding toner, a grip 106b provided on an end face of an insertion direction front side of the cartridge body 106a, and a supply section 106c provided on the insertion direction depth side of the cartridge body 106a.

The cartridge body 106a is cylindrical in shape and has a plurality of helical grooves 106d on its outer peripheral surface. The helical sections 106d are projected on an inner surface of the cartridge body 106a and, by rotating the cartridge body 106a, allows the toner to be supplied to a supply section 106c side.

The grip 106b is so shaped as to correspond to the kind of toner in the cartridge body 106a and, in the present embodiment, has a C-shape configuration. It is to be noted that the shape of the grip 106b may be changed in accordance with the kind of toner cartridge in use at the destination sites. If the shape of the grip 106b is changed in accordance with the kind of toner, then it is possible to identify the kind of toner in the cartridge body from the shape of the grip 106b. A hollow section 106f is provided within the grip 106b. The hollow section 106f communicates with an inner space of the cartridge body 106a. When, therefore, the grip 106b is separated from the cartridge body 106a, an opening is created at the end face of the insertion direction front side of the cartridge body 106a to allow the toner to be flow from within the cartridge body 106a.

The supply section 106c is cylindrical in configuration and a supply hole 106e is provided at the outer peripheral surface to allow the toner within the cartridge body 106a to be supplied to the developing unit 104. The toner within the cartridge body 106a allows only a predetermined amount to be dropped down into the developing unit 104 each time the supply hole 106e is moved downward. By doing so, when the toner within the developing unit 104 is spent, the toner cartridge 106 is rotated a predetermined number of times only to allow a required amount of toner to be supplied to the developing unit 104.

(Structure of Pusher 117)

As shown in FIGS. 5 and 6, the pusher 117 comprises a piston-type cylindrical opening/closing member 117a rotatably coupled to the copying machine body 100, an urging member 117b (support member) provided within the opening/closing member 117a, a spring 117c provided between the opening/closing member 117a and the urging member 117b, and a locking member 117d provided at the opening/closing member 117a.

The opening/closing member 117a comprises a flat-bottomed cylindrical member as a first member 119 and a cylindrical member as a second member 120 arranged on the outer peripheral portion of the first member 119. The second member 120 projects radially inward from the edge end of the first member 119 and prevents the urging member 117b from being ejected out of the opening/closing member 117a.

The urging member 117b is so set as to be rotatable about an axis of the opening/closing member 117a and movable in the axial direction of the opening/closing member 117a. The urging member has a recess 121 on a side opposite to the spring 117c so as to support the grip 106b of the toner cartridge 106. The shape of the recess 121 corresponds to that of the grip 106b of the toner cartridge 106. Even if, therefore, a cartridge having a different grip configuration is to be mounted in the recess 121, this different grip 106b interferes with the urging member 117b, so that it is not fitted in a closed state.

The spring 117c is so urged as to space the urging member 117b away from the opening/closing member 117a. When, therefore, the pusher 117 is fitted in the closed state, the toner cartridge 106 is urged further inside the machine body 100 through the urging member 117b.

The locking member 117d acts as an engaging section for engaging with the copying machine body 100, when the pusher 117 is closed, and prevents the pusher 117 from being opened by a reaction force acting upon the urging member 117b when the toner cartridge 106 is pressed.

(Structure of Drive Unit 118)

As shown in FIG. 5, the drive unit 118 comprises a connection device 122 to which the supply section 106c of the toner cartridge 106 is connected and a drive device 123 rotated about the axis of the connection device 122.

The connection device 122 is of a piston-type cylindrical configuration such that, at a position facing the above-mentioned supply hole 106e when the toner cartridge 106 is mounted, an opening (not shown) is provided to allow a toner which is supplied from the supply hole 106e of the toner cartridge 106 to be dropped down into the developing unit 104.

The drive device 123 has a motor 123a, a plurality of pulleys 123b and a belt 123c and can rotate the connection device 122 by the driving of the motor 123. It is to be noted that the drive device 123 is so adjusted that, upon the exchange of the toner cartridge, the opening of the connection device 122 is oriented upward at all times.

(Exchange Operation of Toner Cartridge)

An explanation will be given below about the function of the electrophotographic machine thus structured.

When a toner within the toner cartridge 106 is spent, the copying machine body 100 is stopped and the cover 100a provided at the side surface of the front side is opened. When the cartridge holding section 100c is seen, the locking member 117d is released and the pusher 117 is opened toward the front side. When the toner cartridge 106 is seen on the inner side of the pusher 117, the grip 106b is grasped and then the toner cartridge 106 is withdrawn toward the front side and an adequately filled toner cartridge 106 is inserted. At this time, care is taken to see that an operation is executed with the supply hole 106e of the toner cartridge 106 kept upward. After the supply section 106c of the toner cartridge 106 has been connected to the connection device 122 of the drive unit 118, the pusher 117 is closed and the toner cartridge 106 is pushed in the insertion direction.

At this time, if the toner cartridge 106 to be attached is a suitable product, then the grip 106b is completely fitted in the recess 121 of the pusher 117 because the shape of the grip 106b of the toner cartridge 106 corresponds to that of the recess 121 of the pusher 117. If not, the grip 106b interferes with the pusher 117 and the pusher 117 is not completely closed.

According to whether or not the pusher 117 is completely closed, it is possible to know that a toner cartridge to be mounted is a suitable product or not. By doing so, it is possible to prevent use of an inappropriate toner cartridge.

When the toner cartridge 106 is correctly mounted, the cover 100a is closed and the copying machine body 100 is set in an operation state. By doing so, the drive unit 118 is driven and the toner cartridge 106 is rotated a predetermined number of times only. By doing so, a predetermined amount of toner is supplied from the supply hole 106e of the toner cartridge 106 into the developing unit 104 and a developing process is again performed. It is to be noted that, at a time of rotating the toner cartridge 106, the urging member 117b of the pusher 117 is rotated as one unit integral with the toner cartridge 106.

(Function of Present Embodiment)

According to the electrophotographic copying machine thus structured, the shape of the grip 106b provided on the end surface of the insertion direction front side of the cartridge body 106a is changed according to the kind of toner in the cartridge body 106a and, at the urging member 117b of the pusher 117, a recess 121 is provided which has a shape corresponding to the grip 106b.

When the toner cartridge 106 is to be attached, it is possible to judge whether or not the toner cartridge 106 is a suitable product from a mating state between the grip 106b and the recess 121. As a result, without the need to apply any work process to the driving unit 118, it is possible to prevent any failure of the electrophotographic copying machine caused by inappropriate use of the toner cartridge.

Further, by careful design of the shape of the grip 106b, it is possible to prevent any mishandling of the toner cartridge 106. In other words, the toner cartridge 106 has an anti-mishandling function to its originally present grip 106b.

For this reason, it is not necessary to provide any new projection on the toner cartridge 106 and hence impart any complex configuration to the toner cartridge 106, thus no increase in the manufacturing cost of the toner cartridge 106 is involved.

Further, the hollow section 106f communicating with the inner space of the cartridge body 106a is formed within the grip 106b. If, therefore, the grip 106b is separated from the cartridge body 106a, then the toner in the cartridge body is spilled, thus no user would go to the trouble of changing the shape of the grip 106b for the purpose of utilizing the toner cartridge 106 of the present embodiment in another electrophotographic copying machine.

Further, if the present invention is applied to a conventional toner cartridge adapted to detect inappropriate use from any mating combination between a projection provided at an insertion position side of the toner cartridge and a recess of an electrophotographic copying machine side, it is possible to improve the possibility of using such projection/recess combinations.

Further, the urging member 117b of the pusher 117 is so mounted as to be rotatable about the axis of the opening/closing member 117a and thus rotatable as one unit integral with the toner cartridge 106. At a time of rotating the toner cartridge 106, therefore, no mutual sliding movement occurs between the urging member 117b and the grip 106b and thus it is possible to prevent the axis of the toner cartridge 106 from being shifted out of a rotation axis due to the grip 106b being worn.

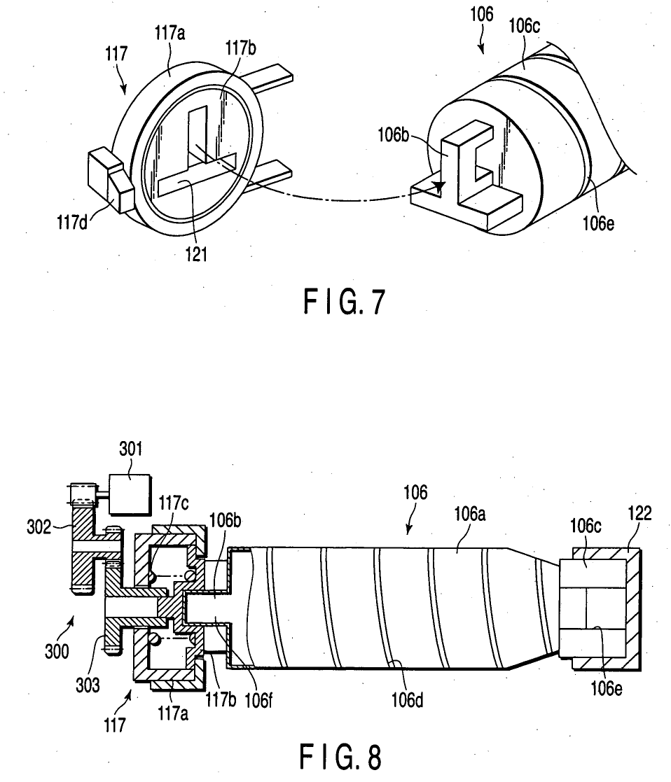

Although, according to the present embodiment, the grip 106b has a U-shape configuration, it is not restricted thereto and it may be a T-like configuration as shown, for example, in FIG. 7. In this case, it is necessary that the recess 121 formed at the urging member 117b of the pusher 117 be also T-like in configuration so as to correspond to the grip 106b. In a color-type electrophotographic copying machine equipped with a plurality of kinds of toner cartridges, if the shape of the grip 106b is changed for each color, it is possible to mount a toner cartridge of a corresponding color without involving any color errors.

### Second Embodiment

The second embodiment of the present invention will be described below with reference to FIG. 8. It is to be noted that, here, any explanation is omitted about the same structure and function as those of the first embodiment.

(Toner Cartridge and its Surrounding Structure)

FIG. 8 is a diagrammatic view showing a toner cartridge 106, a pusher 117 and a drive unit 300 according to the second embodiment of the present invention. As shown in FIG. 8, the drive unit 300 (drive device) is provided on the front side, not on the inner side of a copying machine body 100. The drive unit 300 comprises a motor 301, a first gear 302 rotated by the motor 301 and a second gear 303 rotated by the first gear 302. One end portion of the second gear 303 extends into the pusher 117 from the first member 119 and its forward end portion is coupled to the urging member 117b. When the motor 301 is rotated, the toner cartridge 106 is rotated in the same direction through the urging member 117b. Even if the driving unit 300 for rotating the toner cartridge 106 is provided on the front side of the copying machine body 100 as shown in the present embodiment, it is possible to obtain the same advantages as those of the first embodiment.

In the present embodiment, it is essential to provide the drive unit 300 (drive unit for rotating the toner cartridge) on the front side of the copying machine body 100. In this connection it is to be noted that the type and structure are not restricted to those of the above-mentioned embodiment.

In the first and second embodiments, the toner cartridge 106 is provided with a grip 106b and the pusher 117 is provided with a recess 121. That is, these embodiments utilizes a mating combination between the projection of the toner cartridge 106 and the recess of the pusher 117. However, such a recess and projection may be formed, respectively, at the toner cartridge 106 and pusher 117 and, by doing so, misconnection can be prevented by utilizing the mating combination.

Although, in the first and second embodiments, the present invention has been explained as being applied to the electrophotographic copying machine, it is not restricted thereto and it may be applied to, for example, a facsimile and printer in so far as the apparatus has a detachable toner cartridge.

The present invention is not restricted directly to the above-mentioned embodiments and various changes or modifications of the constituent elements can be made without departing from the spirit and scope of the present invention. Various inventions can be made by properly combining together a plurality of component parts disclosed in the above-mentioned embodiments. For example, some constituent elements may be eliminated from all the component elements shown in the embodiment and, further, those constituent elements of those different embodiments may be properly combined together.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A toner cartridge insertably for use in an image forming apparatus comprising
a cartridge body configured to hold a toner; and
a grip provided on a proximal end of the cartridge body and having such a shape that the toner cartridge is completely inserted into the image forming apparatus when the grip is fitted in a recess or on a projection provided in or on the image forming apparatus, said shape being specific to the toner cartridge or toner contained in the cartridge body.

2. The toner cartridge according to claim 1, wherein, by being fitted in the recess or on the projection which is provided in or on the image forming apparatus, said grip prevents the toner cartridge from being used in any unfit state.

3. The toner cartridge according to claim 1, wherein said grip sets the toner cartridge in a fit state only when being fitted in or on the image forming apparatus.

4. The toner cartridge according to claim 1, wherein a hollow section continuous with the cartridge body is formed in said grip.

5. An image forming apparatus comprising:
an apparatus body;
an image carrier provided within the apparatus body;
an image forming unit provided within the apparatus body and configured to form an electrostatic latent image on the image carrier;
a developing unit provided within the apparatus body and configured to supply a toner to the electrostatic latent image to form a toner image;
a transfer unit provided within the apparatus body and configured to transfer the toner image to a transfer medium;
a rotation type bottle toner cartridge configured to be insertably fitted in the apparatus body to supply the toner to the developing unit; and
a support member provided on a front side within the apparatus body and configured to have a recess or projection for supporting the toner cartridge insertably fitted in the apparatus body, said toner cartridge comprising
a cartridge body configured to hold the toner; and
a grip provided on a proximal end of the cartridge body and having such a shape that the toner cartridge is completely inserted into the image forming apparatus when the grip is fitted in the recess or on the projection, said shape being specific to the toner cartridge or toner contained in the cartridge body.

6. The image forming apparatus according to claim 5, wherein, by being fitted in the recess or on a projection, said grip prevents the toner cartridge from being used in any unfit state.

7. The image forming apparatus according to claim 5, wherein said grip sets the toner cartridge in a fit state only when being fitted in or on the image forming apparatus.

8. The image forming apparatus according to claim 5, wherein said support member is rotated as one unit integral with the toner cartridge.

9. The image forming apparatus according to claim 8, further comprising a drive device provided on a front side and configured to rotate the toner cartridge about its axis.
